(19) United States
(12) Patent Application Publication
(10) Pub. No.: US 2015/0060718 A1
(43) Pub. Date: Mar. 5, 2015

(54) VALVE DIFFUSER FOR A VALVE

(71) Applicant: SIMENES AKTIENGESELLSCHAFT, Munchen (DE)

(72) Inventors: Ralf BELL, Mülheim an der Ruhr (DE); Isabell BÖER, Mülheim an der Ruhr (DE); Thomas FISCHER, Mülheim an der Ruhr (DE); Giuseppe GAIO, Bonn (DE); Raimund HEINZE, Oberhausen (DE); Markus LEGENBAUER, Essen (DE); Damian RAZOWSKI, Mülheim an der Ruhr (DE); Thomas RIEDEL, Mülheim an der Ruhr (DE); Stanislaw RUDA, Moers (DE); Ralf ZIWES, Dinslaken (DE)

(21) Appl. No.: 14/472,915

(22) Filed: Aug. 29, 2014

(30) Foreign Application Priority Data
Aug. 29, 2013 (EP) 13182117.5

(51) Int. Cl. F16K 27/02; B23P 15/00; F16K 1/42

(52) U.S. Cl. CPC F16K 27/0254; F16K 1/42; B23P 15/001
USPC 251/359; 29/890.124

(57) ABSTRACT

A valve diffuser (3) for a valve (1), wherein the valve diffuser (3) has a valve seat (8) to make contact with a valve body. The valve seat (8) has a bushing (10) for making contact with a valve body. The bushing is formed from a different reinforced material wherein the valve diffuser (3) and preferably stellite.

### CROSS-REFERENCE TO RELATED APPLICATIONS

The present application claims priority of European Patent Application No. EP13182117, filed Aug. 29, 2013, the contents of which are incorporated by reference herein.

### TECHNICAL FIELD

The invention relates to a valve diffuser for a valve having a valve seat designed to make contact with a valve body.

### TECHNICAL BACKGROUND

In turbomachines, for example steam turbines, valves are used inter alia for regulating a steam mass flow. For the local supply of power, steam turbines having a comparatively high performance category are required. This has the effect that the valves which are used therefor similarly have a corresponding component size. Valves of this type generally comprise a valve housing and a valve diffuser which is arranged within the valve housing and through which inflowing steam flows. The mass flow of steam is set with the aid of a valve body, which is formed such that it can move in the direction of the valve diffuser. In a completely closed position, the valve cone lies against a sealing surface on a valve seat which is connected to the valve diffuser. In an open position, a through-flow area directly correlated to the mass flow through the valve is formed between the valve cone and the valve seat.

In the closed position, the valve cone bears against the valve seat and forms a contact surface. This contact surface is subjected to higher loading owing to the blows of the valve cone upon closing. In addition to wear phenomena arising from instances of steam erosion, this region is therefore also subjected to wear phenomena arising from instances of mechanical loading. In order to counteract such instances of mechanical loading, the contact surface on the valve seat is generally plated, which is effected for example by stelliting. However, despite the plating, after relatively long operation it is often necessary to refurbish the surface of the valve seat on account of solid state erosion and steam erosion.

Replacement of the entire valve seat would be one possible way of preventing further damage, but the replacement is made more difficult since assembly work on the turbine is generally associated with increased complexity.

It is similarly conceivable to counteract the wear arising from erosion by virtue of an appropriate material selection. Materials of this type are, however, comparatively expensive and damage nevertheless generally arises on the valve seat after a certain operating time. If it is not possible to refurbish a damaged surface of this kind, the valve seat is dismantled and replaced by a new one. In the event of maintenance and during stoppages, the valves are examined and a decision may be made on site as to which measure is required to restore the operation of the valve. Either refurbishment or complete valve replacement is required. Tests such as a dye penetrant test or an ultrasonic test are required for sufficiently good analysis. If a measure is to be taken, there is an appreciable, sometimes extended idle time between when the decision is made and when the measure is taken.

### SUMMARY OF THE INVENTION

It is an object of the invention to improve the availability of a valve.

This object is achieved by a valve diffuser for a valve having a valve seat designed to make contact with a valve body, wherein the valve seat comprises a bushing for making contact with a valve body.

According to the invention, a valve diffuser comprises a bushing which is in contact with the valve body. After specific maintenance intervals defined in advance, this bushing can be replaced irrespective of findings. This saves a large amount of time, since tests are classified as not being necessary from the outset. As a result, the idle times of such a valve are reduced.

In an advantageous development, the bushing is formed from a different reinforced material.

According to the invention, use is advantageously made of a material for the bushing which has a reinforced form compared to the material of the valve diffuser and is therefore less sensitive to the constant contact with the valve body. Any contact of the valve body on the valve diffuser leads to mechanical deformation and to erosion. It is therefore proposed according to the invention to form this region of the contact surface which is formed by the bushing with a material which is reinforced, compared to the valve diffuser. As a result, the mechanical deformation and the erosion are reduced and the service life of the valve is increased.

It is advantageous that the material of the bushing consist of a stellite. In relation to steam states, stellite is a suitable material for counteracting damage. It is advantageous that the bushing has an annular form and that the outer region is formed parallel to the axis of rotational symmetry. The bushing is in this case mounted by being pressed in. In an alternative embodiment, the bushing can have an annular form and the outer region can have a conical form. The outer shape of the bushing therefore has a conical configuration. The greater diameter of the cone is positioned counter to the mounting direction for installing the bushing, and therefore the bushing is fixed in a form-fitting manner. In this respect, the bushing can be mounted, for example, by way of shrink-fitting of the bushing.

It is advantageous that complete replacement of the diffuser or of the valve seat is therefore not necessary. Similarly, it is not necessary to remove the complete valve from the turbine.

It is a particular advantage that maintenance can be planned better in advance and can be carried out more effectively since the bushing may always be replaced irrespective of findings.

As a result, dye penetrant tests and ultrasonic tests can be dispensed with entirely. Complicated and expensive refurbishment which is dangerous to health is not required.

### BRIEF DESCRIPTION OF THE DRAWINGS

The invention will now be explained in more detail on the basis of an exemplary embodiment.

The FIG. 1 schematically shows a cross section of half of a valve according to the invention.

FIG. 2 shows the same section of half of a valve according to the prior art.

### DESCRIPTION OF AN EMBODIMENT

FIG. 1 shows a cross-sectional view of a valve according to the invention.

In FIG. 1, the valve 1 comprises a valve housing 2 and, within the valve housing 2, a valve diffuser 3 of substantially rotationally symmetrical design. An axis of symmetry 4 is indicated in the figure. The valve diffuser 3 has a substantially rotationally symmetrical form in relation to this axis of symmetry 4. The valve diffuser 3 comprises a substantially cylindrical shell region 5, which is formed substantially parallel to the axis of symmetry 4. A conical inner shell region 6, through which steam flows at a comparatively high temperature and high pressure during operation, is formed within the valve diffuser 3. At the start end 7 or inlet of the valve diffuser, the valve diffuser 3 is fixedly arranged on the housing 2.

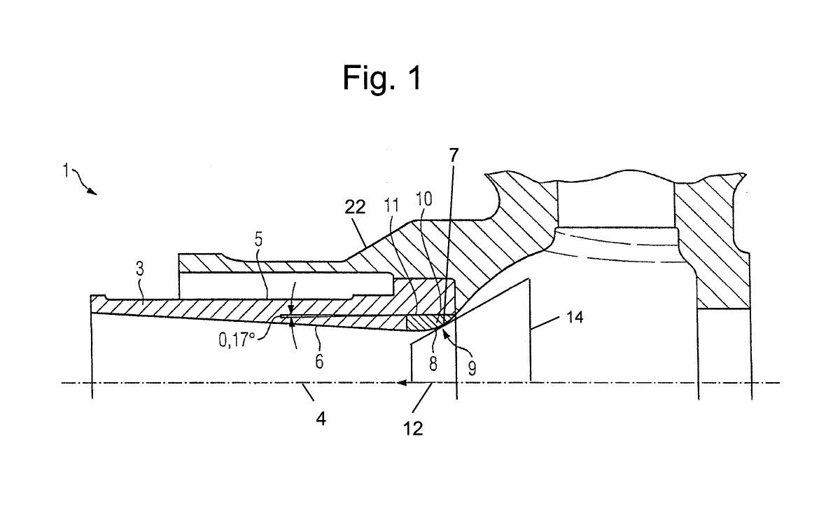

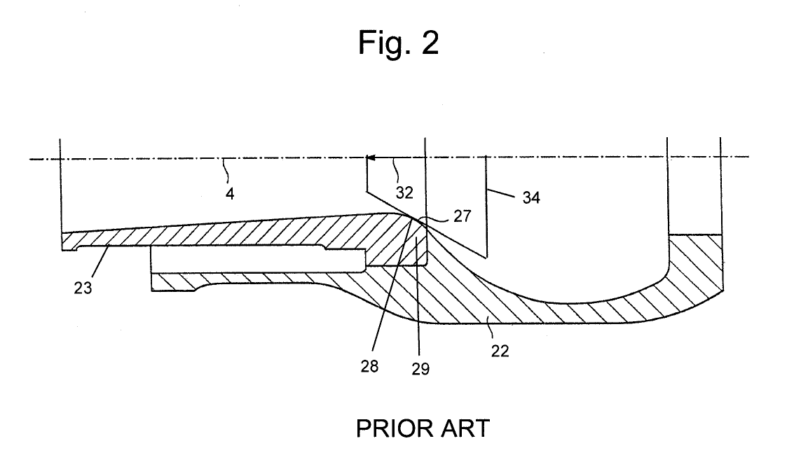

The embodiment shown in FIG. 1 shows the invention above the axis of symmetry 4. The prior art in FIG. 2 is shown beneath the axis of symmetry 4.

The valve diffuser 3 comprises a valve seat 8, which is arranged at the start 7 of the valve diffuser and is designed to make contact with a valve body 14, shown schematically. The valve body is shaped, controlled and moved conventionally, so details thereof are not illustrated. The valve body touches the valve seat 8 substantially in the contact region 9. The contact region 9 is improved by a bushing 10. The bushing 10 now makes the contact with the valve body (not shown in more detail) and is formed from a different reinforced material to the valve diffuser 3. The material of the bushing 10 preferably consists of a stellite alloy. The bushing 10 has a substantially annular form and is adapted to the valve diffuser inner surface. The outer region 11 of the bushing 10 is formed parallel to the axis of symmetry 4.

In an alternative embodiment, the outer region 11 of the bushing 10 has a conical configuration. FIG. 1 shows the angle between the axis of symmetry 4 and the conical outer region 11 of the valve bushing, which angle is substantially 0.17°. A range of values for this angle lie between 0.05° and 0.25°.

The bushing 10 is pressed in. In the case that the bushing 10 has a conical configuration, the bushing 10 is fixed in a form-fitting manner to the valve diffuser, and the greater diameter of the bushing is arranged counter to a mounting direction 12 of the bushing in the diffuser. The bushing 10 can be mounted by shrink-fitting.

In an alternative embodiment, the material of the bushing 10 corresponds to the material of the valve diffuser 3, and the bushing 10 preferably then has a stellite plating.

The prior art in FIG. 2 has direct contact between the valve body and the diffuser 7 at contact region 9. There is no bushing, like 10 in FIG. 1, protecting the diffuser. The above described benefits of the invention are not achieved. In FIG. 2, the elements corresponding to those in FIG. 1 have the same reference numbers, raised by 20.

1. A valve diffuser for a valve: the valve having a valve seat configured to make contact with a valve body; and
the valve seat comprises a bushing at the valve seat for making contact with the valve body of the valve.

2. The valve diffuser as claimed in claim 1, wherein the bushing is formed from a different reinforced material than the valve seat.

3. The valve diffuser as claimed in claim 2, wherein the material of the bushing is a stellite.

4. The valve diffuser as claimed in claim 1, wherein the bushing has a stellite plating thereon.

5. The valve diffuser as claimed in claim 1, wherein the bushing has an annular form and has an outer region formed parallel to an axis of symmetry of the valve.

6. The valve diffuser as claimed in claim 1, wherein the bushing has an annular form and has a radially outer region of a conical form.

7. The valve diffuser (3) as claimed in claim 6, wherein a greater diameter of the conical form is arranged at the valve diffuser end

8. A method for mounting a bushing on a valve diffuser, wherein the diffuser has an open passageway and the diffuser is located in a valve passageway in the valve; and
the method comprises pressing the bushing into the valve diffuser.

9. The method as claimed in claim 8, wherein the valve diffuser is mounted in the valve passageway and the valve diffuser has a passage therethrough having a start end in the valve;
the bushing has a conical form with a greater end;
the method comprising:
arranging the bushing into the passage through the valve diffuser, placing the bushing in the passage with the greater diameter end being at the start end of the passage through the diffuser;
the method comprising:
pressing the bushing into the diffuser body at the start of the diffuser, with the bushing arranged counter to a mounting direction from the start of the passage outward; and
fixing the bushing in a form-fitting manner to the valve diffuser.

10. The method as claimed in claim 8, further comprising mounting the bushing by shrink-fitting of the bushing.
